(19) United States
(12) Patent Application Publication
(10) Pub. No.: US 2026/0307570 A1
(43) Pub. Date: Oct. 8, 2026

(54) Cup Holder for a Motor Vehicle, and Method

(71) Applicant: Mercedes-Benz Group AG, Stuttgart (DE)

(72) Inventors: Andreas SEHMSDORF, Althengstett (DE); Patrick BOEHMLER, Boeblingen (DE)

(21) Appl. No.: 19/482,361

(22) PCT Filed: Apr. 5, 2024
(86) PCT No.: PCT/EP2024/059374

§ 371 Date: Nov. 7, 2025

(30) Foreign Application Priority Data
May 8, 2023 (DE) 10 2023 001 826.0

(51) Int. Cl. B60N 3/10

(52) U.S. Cl. CPC B60N 3/106; B60N 3/108

(57) ABSTRACT

A cup holder for an interior of a motor vehicle includes a receiving opening where a cup or a cylindrical container is receivable through the receiving opening and a base where the cup or the cylindrical container is settable down on the base. A compensating element is disposed on a first interior wall region of an inner circumferential interior wall that extends from the receiving opening as far as the base. A cup or a cylindrical container that is disposed in the cup holder is pressable against a second interior wall region by the compensating element. The compensating element is an arm which is pivotable about a pivot axis. The arm is directed downward in a motor vehicle vertical direction and is pivotable about the pivot axis in a direction of the cup or the cylindrical container that is disposed in the cup holder.

### BACKGROUND AND SUMMARY OF THE INVENTION

The invention relates to a cup holder for a motor vehicle. The invention also relates to a method for operating such a cup holder.

DE 10 2020 105 603 A1 discloses a holder for a drinks container, such as for example a drinks can, which is provided to hold the drinks container in a motor vehicle in a tilt-proof manner. It is disclosed that a support for laterally supporting the drinks container is provided with a support element, which is horizontally pivotably mounted on a support carrier.

A cup holder having a storage space that opens upwards for holding a liquid container is already disclosed in DE 10 2009 053 397 A1, wherein the storage space is delimited by a base and at least partially by a casing. The cup holder comprises at least one temperature control element, which is arranged in the casing of the storage space. The cup holder has flexible holding means for securely fixing containers of different size in position.

Additionally, different noteworthy devices for holding cups or similar containers are disclosed in DE 10 2019 119 370 B4, JP 2008-114 653 A, KR 10 2019 137 541 A, DE 10 2006 032 883 A1 and DE 10 2009 058 957 A1.

The object of the invention is to provide a cup holder for a motor vehicle, by means of which different cups of cylindrical containers having different geometries can be held particularly reliably and efficiently.

Advantageous embodiments of the cup holder according to the invention can be considered to be advantageous embodiments of the method according to the invention, wherein the means of the cup holder are used to carry out the method steps.

A first aspect of the invention relates to a cup holder for an interior of a motor vehicle, in particular of a passenger car. The cup holder comprises at least one in particular round receiving opening for receiving a cup or a cylindrical container or a bottle or further elements for receiving liquids and also comprises a base for setting down the cup or cylindrical container that has been guided through the receiving opening. It is provided that at least one compensating element is arranged on a first side wall extending from the receiving opening as far as the base, by means of which compensating element the cup or the cylindrical container can be pressed against a second side wall opposite the first side wall. In particular, in this case, the side walls can be partial regions of a casing which extends from the receiving opening inner circumferentially as far as the base and is held on the base around a base surface of the base.

It is also provided that the compensating element is designed as an arm which can be pivoted about an axis. Further advantages result from the embodiment of the compensating element as an arm which can be pivoted about an axis. The arm can be brought into different positions, in order to enable it to better adapt to different container sizes. Therefore, the cup holder can be used even more flexibly and offers an even greater variety of use possibilities. Additionally, the pivotable arm can be positioned so that it securely and stably holds the cup and/or a small and/or cylindrical container, without affecting the use of the cup holder.

In order to solve the object of the invention and thus to provide a cup holder for a motor vehicle, by means of which different cups or cylindrical containers having different geometries can be held reliably and efficiently, it is provided according to the invention that the pivotable arm is directed downwards in the vehicle vertical direction and can be pivoted about the axis in the direction of the cup or cylindrical container. Thus, the pivotable arm is directed downwards in the vehicle vertical direction and is pivoted about the axis in the direction of the cup, so that the cup coming from above in the vehicle vertical direction cannot become wedged in place. Therefore, handling of the cup holder is also improved, as the cup or the container can be inserted and removed simply and without jamming.

In other words, a cup holder for the interior of the motor vehicle is provided, which contains the one or more receiving openings for receiving cups or other cylindrical containers. The receiving opening is arranged substantially in an upper region of the cup holder in the vehicle vertical direction, so that the occupant can conveniently and ergonomically put their cup or cylindrical container into the cup holder. The base of the cup holder is constructed so that the occupant can securely set down the cup or the cylindrical container that has been guided through the receiving opening, in particular also in relation to the receiving region a small container, for example a can, and the cup holder receives and/or holds the cup and/or a small and/or cylindrical container reliably and substantially without spilling the contents.

To support this receiving or holding, the compensating element is provided and is arranged on the first side wall of the cup holder and is constructed so that it can press the cup and/or small and/or cylindrical containers against the second side wall of the cup holder. The cup and/or the small and/or cylindrical container is stabilized by this pressure and can no longer fall over or tilt so easily. The compensating element can be produced from different materials, such as rubber or plastic. It is important that the material of the compensating element is soft enough to hold the cup and/or a small and/or cylindrical container but also simultaneously firm enough to exert the necessary pressure to press the cup and/or the small and/or the cylindrical container against the second side wall. In particular, the compensating element can also have a soft region oriented towards the cup and a harder partial region oriented away from the cup, which are installed corresponding to each other; in particular here a mixture of hard plastic and soft foam can be used.

The use of a compensating element thus increases the stability and security of the cup holder and provides the user with an improved user experience, wherein the compensating element is designed to hold the cup and/or small and/or bulbous bottles and/or cylindrical containers in an upright position, even when the cup holder experiences an uneven or sudden movement of the motor vehicle. This increases the security and prevents the liquids or other contents from being spilled from the cup or container. Furthermore, the compensating element allows an improved adaptation or fit for different sizes of cups and/or small and/or bulbous and/or cylindrical containers. The compensating element can be arranged in different ways in order to enable appropriate adaptation to the size of the cup. This means that the cup holder can receive a wider variety of container sizes with different geometries and thus is more versatile and practical.

In summary, the cup holder having a compensating element provides improved stability, security and adaptability for the transport of cups with drinks or other cylindrical containers in the motor vehicle.

In a further embodiment, the arm of the cup holder, which can be pivoted about an axis, can have a spring element or a spring mechanism, in order to hold the arm in a specified position. The spring mechanism can be designed, for example, as a screw spring or as a torsion spring. Due to the spring mechanism, it is possible for the arm of the cup holder to remain in the desired position and not be unintentionally displaced into another position. Therefore, the stability and security of the cup in the holder is further increased. In particular, in the event of bumpy road conditions or sharp accelerating and braking manoeuvres, the spring mechanism of the arm can contribute to stably holding the cup in the cup holder and the contents is not tilted or spilt. Furthermore, the spring element or the spring mechanism can also facilitate the adjustment of the cup holder by bringing the cup holder into an optimum position for the user with the pivotable arm, without the user having to use their hand to readjust the cup. In summary, the embodiment of the compensating element as the arm which can be pivoted about an axis provides a further useful function for the cup holder, with which the adaptability and user-friendliness is at least partially increased.

In a further advantageous embodiment of the invention, it is provided that a sensor device is arranged on the compensating element, by means of which sensor device a contact force of the compensating element against the cup or against the cylindrical container can be controlled. Thus, a sensor is arranged on the compensating element, which gauges a force or pressure between the compensating element and the cylindrical container. This force or this pressure can then in particular be automatically controlled, in order to ensure that the container is pressed evenly against the side wall while it is being held. The contact force of the compensating element can be controlled in different ways. One possibility is that the sensor device is connected to a regulating system which automatically adapts the contact force, in order to ensure that the right force is exerted on the cylindrical container.

In an advantageous embodiment of the cup holder, a pivotable arm can be pivoted by means of an actuator. The actuator can be an electric or hydraulic drive which pivots the arm about the axis, in order to hold the cup and/or a small and/or cylindrical container. Additionally, the sensor device is on the compensating element. In other words, a motor or other drive mechanism can be arranged and controlled. The sensor device, which is arranged on the compensating element, gauges the force or the pressure which is exerted on the cup and/or a small and/or cylindrical container while it is being held, and a regulating system adapts the contact force or the contact pressure accordingly, in order to ensure that the cup is pressed evenly. Similarly, it is possible to adapt the regulating system depending on a driving style of the occupant, in order to optimize the holding of the cup; in particular, different parameters of the driving style, such as the speed, acceleration and deceleration, can be taken into account.

In a further advantageous embodiment of the invention, it is provided that the base has an inlay mat having a first partial region angled towards the base and a second partial region and/or partial region that is height-adjusted relative to the base. The height adjustment is in particular provided by a thickness of the inlay mat, alternatively by the thickness of a plurality of inlay mats arranged on top of each other. The cup holder is designed so that it has in particular an inlay mat, which in turn has two partial regions, specifically an oblique and a planar partial region. These two partial regions allow the cup holder to receive and/or containers of different sizes; in particular, by means of the angled first partial region, it is to be possible to also receive cans and/or bulbous and/or small bottles. Such small containers such as the cans stand on the angled surface of the first partial region and lean against a side wall of the cup holder. In order to ensure that the can remains stable and does not tip over, at least one moveable compensating element is arranged, which presses the can against the side wall. In particular, the inner side wall of the cup holder can be at an angle, whereby the angled first partial region can be angled at such an angle corresponding to the oblique side wall that the can, which is substantially 90° to an edge, can be placed down and therefore make contact with the side wall and with the angled first partial region. The second partial region of the inlay mat is designed in particular to be planar and can hold the container in a perpendicular position depending on the size of the container. In particular, cups having a cylindrical shape tapering downwards in the vehicle vertical direction can be provided with a placement surface by way of the second flat or planar partial region, wherein the receiving opening holds the outer circumference of such a cup. In summary, such an inlay mat in the cup holder provides a practical way to securely and stably receive different types of cups or small and/or cylindrical containers. Also, the inlay mat can be made from a flexible material, such as rubber, silicone or foam, and can be adjusted into different positions inside the cup holder, in order to receive tall cups or cylindrical or small, bulbous containers.

In yet a further advantageous embodiment of the invention, it is provided that it is characterized in that the inlay mat is height-adjustable, for example by means of an arranged actuator, which, for example, is arranged below the inlay mat. The actuator can be, for example, an electric motor, a hydraulic cylinder or a pneumatic piston, which changes the position of the inlay mat inside the cup holder. Therefore, the inlay mat can be adapted to different container heights to enable optimum stability and security during the holding. The height adjustment of the inlay mat can be provided by both the actuator and also by further different mechanisms, such as a thread system which moves the inlay mat upwards or downwards. Due to the use of the actuator or further mechanisms, the inlay mat can be adjusted automatically, whereby greater efficiency and user-friendliness of the cup holder can be achieved. The actuator can also be controlled by the aforementioned regulating system, which detects the size of the cup or the cylindrical container, for example by means of a visual detecting device or further sensor devices, and takes this into account in the adjustment.

In yet a further advantageous embodiment of the invention, it is provided that the plane of the inlay mat can be adjusted to correspond to a base surface of the cup or of the cylindrical container. In this embodiment, it is provided that the adjustable inlay mat can be adjusted not only in its height and position, but also in its plane. This means that the inlay mat can be set to correspond to the base surface of the cup or the cylindrical container. This is particularly advantageous when the cup holder has a shape that tapers cylindrically from top to bottom in the vehicle vertical direction, which leads, when the cup is pressed against the side wall, to the cylindrical cup without a tapering shape being tilted, whereby the base of the cup is not placed on the inlay mat. As a result, the cup has an uneven or oblique base surface, which can be evened out by the plane-adjustable inlay mat. This enables maximum stability and security when holding the cup. The plane of the inlay mat can be adjusted by different mechanisms, such as, for example, by a ball joint or a pivot joint, which allows the inlay mat to bend or tilt at different angles. Alternatively, an electrical actuator or a hydraulic cylinder can also be used, in order to adjust the inlay mat in the plane. In other words, due to the corresponding tilting of the inlay mat relative to the base surface of the cup, it is ensured that the cup is held stable during the journey.

In yet a further advantageous embodiment of the invention, it is provided that the inlay mat is designed to gradually adjust a height of the respective partial regions of the inlay mat. Due to the gradual adjustment of the height of the respective partial regions of the inlay mat, a more precise adaptation to the shape of the cup or to the base of the cup can be achieved. It also allows adaptation to cups which are not perfectly cylindrical, as the inlay mat can be set to be higher or lower at specific points. For the gradual adjustment of the inlay mat, a pneumatic or hydraulic system can be used. This system uses air pressure or hydraulic liquid in order to raise or lower the inlay mat. An actuator moves the inlay mat by applying pressure or vacuum in the corresponding regions. The pneumatic or hydraulic system provides the advantage of fast and precise adaptation of the inlay mat to the shape of the container. It can also allow automatic adaptation if the cup holder is equipped with a corresponding sensor device which detects the shape of the cup and adapts the settings of the inlay mat accordingly.

In yet a further advantageous embodiment of the invention, it is provided that a plurality of compensating elements is arranged on a circumferential interior wall of the cup holder, which in each case are designed to be pivoted about a respective axis. The arrangement of a plurality of compensating elements on a circumferential interior wall of the cup holder allows a more precise adaptation to the shape of the cup. Each compensating element is designed to be pivotable about a respective axis, which means that it can rotate about its own axis, in order to better balance the cup. Due to this arrangement, the compensating elements can be oriented at different angles, in order to balance containers having different diameters or shapes. Each compensating element can be pivoted independently of each other, in order to enable individual adaptation to the respective cup.

Lastly, it is provided in yet a further advantageous embodiment of the invention that the plurality of compensating elements can be controlled at least partially automatically. The pivotability of the compensating elements can be realized by a respective actuator or a motor. The actuator or motor can be programmed so that it automatically orients the compensating elements in the right position once a cup is inserted into the cup holder. Similarly, a corresponding sensor device can be used to detect the position of the cup in the cup holder and to adjust the compensating elements accordingly, A further aspect of the invention also relates to a method for operating a cup holder for an interior of a motor vehicle according to the preceding aspect, in which the cup or the cylindrical container is pressed against a second side wall opposite the first side wall by means of at least one compensating element arranged on a first side wall extending from the receiving opening as far as the base. The method for operating the cup holder substantially comprises the following steps.

Placing the cup or the cylindrical container in the receiving opening of the cup holder. Activating the compensating element or the compensating elements which are arranged on the first side wall of the cup holder. The compensating element or the compensating elements press the cup or the container against the second side wall, opposite the first side wall, of the cup holder. Optionally monitoring the contact force of the compensating element or the compensating elements by means of a sensor device which is arranged on the compensating element or on the compensating elements. Adapting the contact force of the compensating element or the compensating elements, if needed, in order to ensure that the cup or the container is held stably and securely in the cup holder. Optionally adjusting the inlay mat, if present, in order to ensure that the base of the cup or the container rests on the inlay mat and does not tilt. Due to this method, it is enabled that the cup or the cylindrical container is held stably in the cup holder without tilting or falling over while the motor vehicle is moving.

In summary, the invention relates to a cup holder for the interior of a motor vehicle. The cup holder contains at least one round or oval opening for receiving cups, bottles or similar cylindrical containers as well as a base for setting down the container. In order to reliably and efficiently hold different cup geometries, at least one compensating element is arranged on a first side wall which extends from the base as far as the opening. This element can be produced from rubber or plastic and is soft enough to hold the container but firm enough to press it against the second side wall. Therefore, the container is stabilized and cannot be tilted so easily, even when the cup holder is subjected to an uneven or sudden movement of the motor vehicle. The compensating element allows an improved adaptation to different container sizes and geometries. In particular, the occupant is provided with an ergonomic way to set down their drinks holder in the motor vehicle and be sure that substantially no content will spill out. A plurality of drinks holders can also be received in the cup holder.

Further advantages, features and details of the invention can be seen from the following description of preferred exemplary embodiments and with reference to the drawings. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWINGS

FIG. 1 is a first schematic side view of a first embodiment of a cup holder for a large container for an interior of a motor vehicle;

FIG. 2 is a second schematic side view of the first embodiment of the cup holder for further cups or cylindrical in particular small containers;

FIG. 3 is a first schematic plan view of a base of the cup holder to illustrate planar and bevelled partial regions on the base, in particular for holding the cup or cylindrical and/or small containers;

FIG. 4 is a second plan view of a further base of the cup holder to illustrate possible height-adjustable increments of an inlay mat of the cup holder;

FIG. 5 is a schematic perspective view of the further base of the cup holder to illustrate possible increments of the inlay mat of the cup holder;

FIG. 6 is a further schematic plan view of the base of the cup holder to illustrate a plurality of compensating elements in a base region of the cup or cylindrical containers; and

FIG. 7 is a further schematic plan view of the base of the cup holder to illustrate a further embodiment of the plurality of compensating elements in a base region of the cup or cylindrical containers.

### DETAILED DESCRIPTION OF THE DRAWINGS

In the figures, identical and functionally identical elements are provided with the same reference signs.

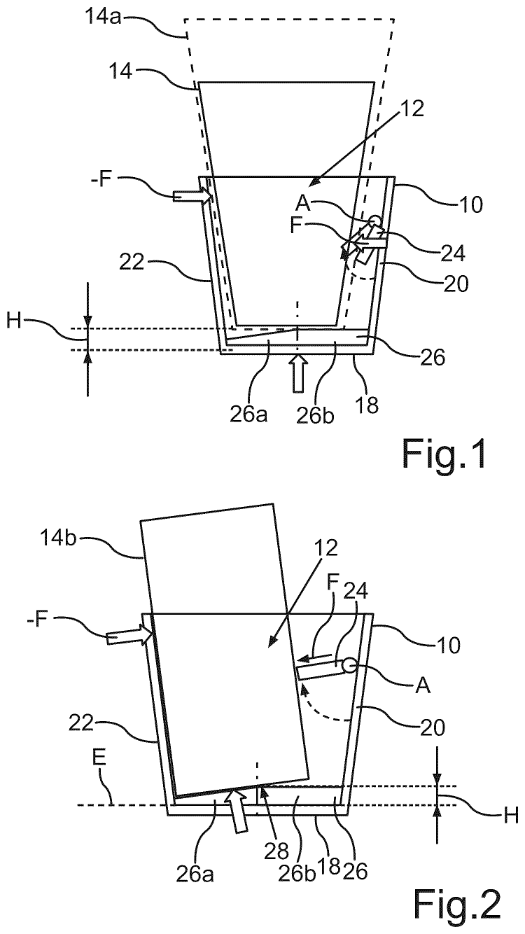

FIG. 1 shows a first schematic side view of a first embodiment of a cup holder 10 for cups 14 or cylindrical containers 14a, 14b for an interior of a motor vehicle, wherein in particular two coffee cups of different size are illustrated as the cups 14. The cup holder 10 is equipped with at least one receiving opening 12, which serves to receive a cup 14 or a similar cylindrical container 14a, 14b. The cup holder 10 has a base 18, on which the cup 14 that has been guided through the receiving opening 12 or the container 14a, 14b can be set down. It is provided that at least one compensating element 24 is arranged on a first interior wall region 20 of the interior wall which extends from the receiving opening 12 as far as the base 18.

The cup holder 10 having the at least one receiving opening 12 thus has the at least one compensating element 24 on the first interior wall region 20 of the inner circumferential interior wall extending from the receiving opening 12 as far as the base 18, by means of which compensating element the cup 14 or the cylindrical container 14a, 14b can be pressed against a second interior wall region 22 differing from the first interior wall region 20, in particular a substantially opposite second interior wall region 22. This compensating element 24 allows the cup 14 or the cylindrical container 14a, 14b to be pressed against the second interior wall region 22 differing from the first interior wall region 20. In this manner, the cup 14 or the cylindrical container 14a, 14b is held or fixed in the cup holder 10 during the journey of the motor vehicle and cannot fall over, slide about or tip over. Thus, the cup holder 10 is designed particularly to be practical and user-friendly, as it holds the cup 14 or the cylindrical container 14a, 14b securely and prevents undesired spilling of liquids during the journey.

The base 18 has an inlay mat 26 having a first partial region 26a angled towards the base 18 and a second partial region 26b that is planar and/or height-adjusted relative to the base 18. The second partial region 26b of the inlay mat 26 is height-adjusted and can hold the cup in a perpendicular position depending on the size of the cup 14. In particular, a cup 14a having a cylindrical shape tapering downwards in the vehicle vertical direction z can be provided with a placement surface by way of the second flat or planar partial region 26b, wherein the receiving opening 12 holds the outer circumference of such a cup 14a; the compensating element 24 can be used to hold the cup 14a if the latter has alternative, smaller dimensions.

In summary, FIG. 1 shows a large container 14a, which is positioned on a planar plane, inside the inlay mat 26, and is fixed by at least one lateral holding arm or compensating element 24.

FIG. 2 shows a second schematic side view of the first embodiment of the cup holder 10 for further cups 14 or cylindrical containers 14a, 14b, wherein in particular a can is illustrated as the cup 14, which in turn has different proportions and geometries than the coffee cups illustrated in FIG. 1. Containers designed in another way can also be received, for example small bulbous vessels.

In the case of the cup holder 10 illustrated in FIG. 1 and FIG. 2, the compensating element 24 is designed as an arm which can be pivoted about a pivot axis A. It is possible to operate the compensating element 24 with an actuator, which, for example, controls the movement of the compensating element 24 by moving or pivoting the arm about the pivot axis (A). A sensor device can also be arranged on the arm, for example, by means of which sensor device a contact force F of the compensating element 24 against the cup 14 or the cylindrical container 14a, 14b can be controlled. Therefore, the sensor device gauges the contact force F or a pressure, which is exerted by the compensating element 24 on the cup 14, and adjusts the contact force F automatically to the size and shape of the cup 14. It is provided for this purpose that the sensor device on the compensating element 24 gauges the contact force F on the cup 14 and gives feedback to the actuator, in order to adapt the movement of the arm accordingly. Alternatively, the sensor device can also be arranged on the second interior wall region 22 and can detect a contact force −F caused by the cup 14, which is created by the cup 14 being pressed by means of the compensating element 24 against the, for example, opposite first interior wall region 20. In particular, the actuator can adapt the contact force F, −F of the compensating element 24 to the cup 14 or the cylindrical container 14a, 14b in real time. Therefore, in particular, the contact force F, −F with which the cup 14 is held in the cup holder 10 can be individually adapted to the respective cup 14 or the cylindrical container 14a, 14b.

The base 18 has an inlay mat 26 having a first partial region 26a angled towards the base 18 and a second partial region 26b height-adjusted relative to the base 18. The cup holder 10 is designed so that it has at least this one inlay mat 26, in particular further inlay mats 26 designed in other ways can also be introduced into the cup holder 10, which in turn have partial regions designed in other ways. The inlay mat 26 in FIG. 2 thus shows an oblique and a planar partial region 26a 26b. These two partial regions 26a, 26b allow the cup holder 10 to receive a container 14b designed as a can, which stands on the angled surface of the first partial region 26a and leans against a side wall in the interior wall region 22 of the cup holder 10. In order to ensure that the can remains stable and does not tip over, at least one moveable compensating element 24 is arranged which presses the can against the side wall. In particular, here the inner side wall of the cup holder 10 is illustrated at an angle, whereby the angled first partial region 26a is angled at such an angle corresponding to the oblique side wall that the can, which is substantially 90° to an edge, can be placed down and thereby makes contact with the side wall and with the angled first partial region 26a.

The base 18 of the cup holder 10 can also be equipped with an adjustable inlay mat 26. In particular, this inlay mat 26 is height-adjustable and its plane E can be adapted according to the base surface 28 of the cup 14 or the cylindrical container 14a, 14b. The inlay mat 26 is designed, for example, so that a height H of a respective partial region 26a, 26b can be adjusted gradually. Therefore, the inlay mat 26 can be adapted individually to different cup sizes, in order to facilitate secure and stable holding. In order to adjust the height H of the inlay mat 26, an actuator can be provided, for example, which, for example, is arranged below the inlay mat 26. The actuator can be, for example, an electric motor, a hydraulic cylinder or a pneumatic piston, which changes the position of the inlay mat 26 inside the cup holder 10. Therefore, the inlay mat 26 can be adapted to different container heights, in particular to enable optimum stability and security during the holding.

The inlay mat 26 can also be designed to be adjustable in its own plane E, in order to correspond to the base surface 28 of the cup 14 or the cylindrical container 14a, 14b. The inlay mat 26 can be designed so that it can be adjusted gradually, whereby the height H of each partial region 26a, 26b can be adapted individually. Therefore, the inlay mat 26 can be adjusted to a plurality of cup sizes and shapes.

The combination of the arm which can be pivoted about a pivot axis A and the height-adjustable inlay mat 26 ensures a particularly flexible and adaptable construction of the cup holder 10. The adaptation to different cup sizes and shapes is therefore facilitated and the holding of the cup 14 or the cylindrical container 14a, 14b in the cup holder 10 is optimized.

In summary, FIG. 2 shows a small container 14b, in particular a can, which is positioned on an oblique surface inside the above-mentioned inlay mat 26 and is fixed with respect to the side wall by the above-mentioned lateral holding arm or compensating element 24, wherein the holding arm or the compensating element 24 is therefore fully extended.

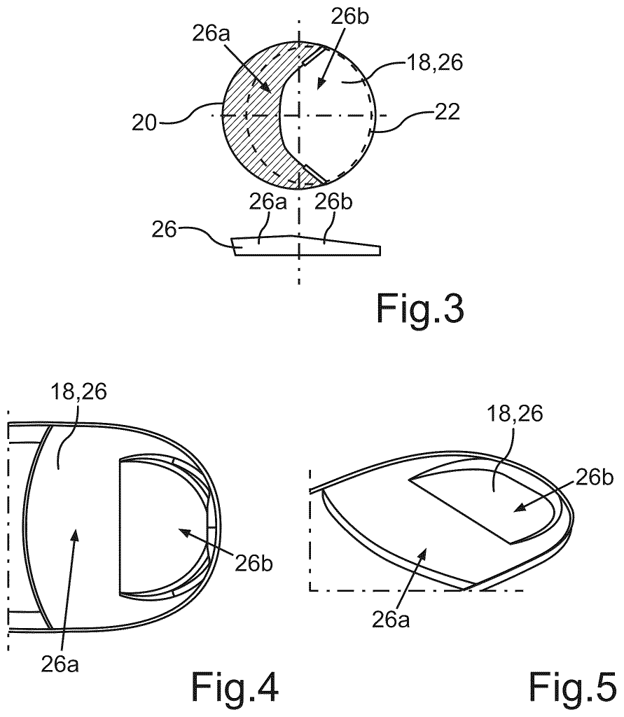

FIG. 3 shows a first schematic plan view of the base 18 of the cup holder 10 to illustrate possible adjustments for holding the cup 14 or the cylindrical container 14a, 14b. In order to be able to adapt different increments of the inlay mat 26 individually to different cup sizes, the respective partial regions 26a, 26b are height-adjustable. To this end, an actuator can be used which, for example, is arranged below the inlay mat 26 and changes the position of the inlay mat 26 inside the cup holder 10. In particular, a base socket can be provided for the cup 14 by adjusting the partial regions 26a, 26b, by means of which the cup 14 is held particularly stable.

FIG. 4 also shows a second plan view of a further base 18 of the cup holder 10 to illustrate possible increments of the inlay mat 26 of the cup holder 10.

Furthermore, FIG. 5 shows a corresponding first schematic perspective view of the base 18 of the cup holder 10 to illustrate the possible increments of the inlay mat 26. Due to the use of an actuator, the height H of the inlay mat 26 can be adapted gradually and individually to the height of the respective cup 14. Therefore, it is ensured that the cup 14 is held stably and securely in the cup holder 10, without tipping, shaking or falling over.

FIGS. 3, 4 and 5 show in particular the two partial regions 26a, 26b of the inlay mat 26, which are designed to be planar and oblique and can also be referred to as stand regions.

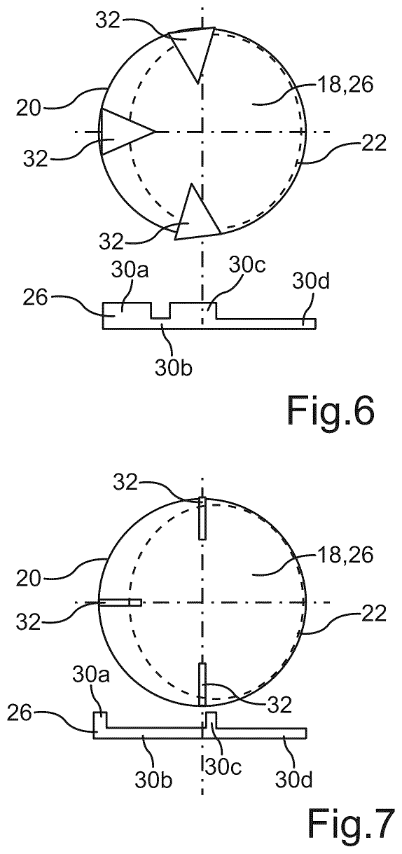

FIG. 6 shows a second schematic plan view of the base 18 of the cup holder 10 to illustrate a plurality of compensating elements 32 in a base region of the cup 14 or the cylindrical container 14a, 14b. In this embodiment, the cup holder 10 is equipped with the plurality of compensating elements 32, in particular with three respective different compensating elements 32, arranged on the circumferential interior wall, which hold the cup 14 from different positions.

The compensating elements 32 are controlled, for example, at least partially automatically and this control can take place based on sensors or other information which detects the distance, the size or the shape of the cup 14 or the cylindrical container 14a, 14b. Due to the use of several compensating elements 32, the cup holder 10 can become even more flexible in order to receive a plurality of cups 14 with unconventional geometries. In particular, FIG. 6 shows a side view of the inlay mat 26, using which it can be seen that the compensating elements 32 can be arranged in the base region of the cup 14 and the inlay mat 26 has respective partial regions 30a, 30b, 30c, 30d by way of which the cup 14 is held on the base region.

Lastly, a triangular design of the compensating element 32 is illustrated in FIG. 6. Here, the compensating elements 32 are triangular and are not pivoted, but instead raised, in order to adapt to the base region of the cup 14. Due to this adaptation, the compensating elements 32 can enable stability by providing a fixed support for the cup base. For example, the compensating elements 32 could be moved by an actuator, which raises and lowers them, or spring mechanisms could also be used, in order to hold the compensating elements 32 in position.

FIG. 7 shows a third schematic plan view of the base 18 of the cup holder 10 to illustrate a further embodiment of the plurality of compensating elements 32 in the base region of the cup 14 or of the cylindrical container 14a, 14b. In particular, FIG. 7 similarly shows a side view of the inlay mat 26, using which it can be seen that the compensating elements 32 can be arranged in a base region of the cup 14 and the inlay mat 26 has respective partial regions 30a, 30b, 30c, 30d, by way of which the cup 14 is held on the base region. The exact embodiment of the compensating elements 24 depends on different factors, such as for example the size and shape of the cup 14, which illustrated in FIG. 7, exhibits a particularly simple elongated embodiment.

In other words, FIGS. 6 and 7 shows different design possibilities of the partial regions 30a-30d of the inlay mat 26 using different support ribs. In particular, an inlay mat 26 can also have different embodiments with different increments for different containers 14a, 14b; in particular, combinations of inlay mats 26 can also be introduced into the cup holder 10.

In summary, the cup holder 10 for a motor vehicle consists of a circumferential interior wall having a receiving opening 12 for receiving cups 14, which are pressed against the interior wall by means of pivotable compensating elements 24.

The invention proposes a structural design of cup holders 10 to increase the stability of the cup 14 or cylindrical containers 14a, 14b.

1.-9. (canceled)

10. A cup holder (10) for an interior of a motor vehicle, comprising:
a receiving opening (12), wherein a cup (14) or a cylindrical container (14a, 14b) is receivable through the receiving opening (12);
a base (18), wherein the cup (14) or the cylindrical container (14a, 14b) is settable down on the base (18); and
at least one compensating element (24) disposed on a first interior wall region (20) of an inner circumferential interior wall that extends from the receiving opening (12) as far as the base (18), wherein a cup (14) or a cylindrical container (14a, 14b) that is disposed in the cup holder (10) is pressable against a second interior wall region (22) that differs from the first interior wall region (20) by the at least one compensating element (24);
wherein the at least one compensating element (24) is an arm which is pivotable about a pivot axis (A);
wherein the arm is directed downward in a motor vehicle vertical direction and is pivotable about the pivot axis (A) in a direction of the cup (14) or the cylindrical container (14a, 14b) that is disposed in the cup holder (10).

11. The cup holder (10) according to claim 10, further comprising a sensor device, wherein the sensor device is disposed on the at least one compensating element (24) and wherein a contact force (F) of the at least one compensating element (24) against the cup (14) or cylindrical container (14a, 14b) that is disposed in the cup holder (10) is controllable by the sensor device.

12. The cup holder (10) according to claim 10, further comprising an inlay mat (26), wherein the inlay mat (26) has a first partial region (26a) that is angled toward the base (18) and a second partial region (26b) that is height-adjustable relative to the base (18) and/or is planar relative to the base (18).

13. The cup holder (10) according to claim 12, wherein a plane (E) of the inlay mat (26) is adjustable to correspond to a base surface (28) of the cup (14) or of the cylindrical container (14a, 14b) that is disposed in the cup holder (10).

14. The cup holder (10) according to claim 12, wherein the inlay mat (26) is configured to gradually adjust a respective height (H) of the first partial region (26a) and the second partial region (26b).

15. The cup holder (10) according to claim 10, further comprising an inlay mat (26), wherein the inlay mat (26) is height-adjustable.

16. The cup holder (10) according to claim 15, wherein a plane (E) of the inlay mat (26) is adjustable to correspond to a base surface (28) of the cup (14) or of the cylindrical container (14a, 14b) that is disposed in the cup holder (10).

17. The cup holder (10) according to claim 10, wherein the at least one compensating element comprises a plurality of compensating elements (24) that are disposed on the inner circumferential interior wall and wherein each of the plurality of compensating elements (24) are pivotable about a respective pivot axis (A).

18. The cup holder (10) according to claim 17, wherein the plurality of compensating elements (24) are controllable at least partially automatically.

19. A method for operating the cup holder (10) according to claim 10, comprising the steps of:
pivoting the arm about the pivoting axis (A) in a direction of a cup (14) or a cylindrical container (14a, 14b) that is disposed in the cup holder (10); and
pressing the cup (14) or the cylindrical container (14a, 14b) against the second side wall by the at least one compensating element (24).
